(19) United States
(12) Patent Application Publication
(10) Pub. No.: US 2021/0254511 A1
(43) Pub. Date: Aug. 19, 2021

(54) Nested Loop Supercritical CO2 Waste Heat Recovery System

(71) Applicant: RESOLUTE WASTE ENERGY SOLUTIONS, Houston, TX (US)

(72) Inventors: Jesse Mark BRUMBAUGH, Houston, TX (US); Thomas S. LAIRD, Portland, TX (US)

(21) Appl. No.: 17/257,143

(22) PCT Filed: Jul. 9, 2019
(86) PCT No.: PCT/US2019/041021

§ 371 Date: Dec. 30, 2020

Related U.S. Application Data
(60) Provisional application No. 62/696,342, filed on Jul. 11, 2018.

(51) Int. Cl. F01K 25/10

(52) U.S. Cl. CPC F01K 25/103; F05D 2260/213; F05D 2220/31; F05D 2210/12

(57) ABSTRACT

According to some embodiments, a supercritical waste heat recovery system comprises a first heat exchanger operable to introduce waste heat into a primary loop working fluid; a first turboexpander operable to expand the primary loop working fluid to produce electricity and/or mechanical work; a second heat exchanger operable to reject heat from the primary loop working fluid and introduce heat into a secondary loop working fluid; a third heat exchanger operable to reject additional heat from the primary loop working fluid; a first compressor operable to increase pressure of the primary loop working fluid; a second turboexpander operable to expand the secondary loop working fluid to produce electricity and/or mechanical work; a fourth heat exchanger operable to reject heat from the secondary loop working fluid; and a second compressor operable to increase pressure of the secondary loop working fluid.

### RELATED APPLICATIONS

This application claims priority to U.S. Provisional Application Ser. No. 62/696,342, entitled “Nested Loop Supercritical CO2 Waste Heat Recovery System,” filed Jul. 11, 2018.

### TECHNICAL FIELD

This disclosure relates to waste heat recovery systems used for power generation, particularly those utilizing supercritical carbon dioxide as a working fluid.

### BACKGROUND

A waste heat recovery system (WHRS) is typically used to convert thermal energy into other forms of useful energy such as electricity or mechanical work. A WHRS utilizes one or more chemical compounds, such as water or an organic compound, as a working fluid to transfer energy. The Rankine Cycle is a thermodynamic process used to extract heat and convert it into electricity. When using organic compounds as the working fluid, the process is known as the Organic Rankine Cycle (ORC). A heat recovery steam generator (HRSG) is a common WHRS using water as a working fluid to produce steam used for power generation.

Carbon dioxide (CO2) has been gaining interest as an alternative working fluid for a WHRS because of its relatively low supercritical point versus other working fluids in the temperature ranges of interest. In addition, CO2 is nonflammable and non-toxic.

Supercritical fluids exhibit high densities similar to liquids, no surface tension similar to gases, and other properties falling between that of a liquid and gas. Piping and equipment may be designed to operate within the supercritical region of CO2. The high densities facilitate smaller equipment such as smaller condensers and turbines for handling the fluid compared to a HRSG.

### SUMMARY

According to some embodiments, a supercritical waste heat recovery system comprises a first heat exchanger operable to introduce waste heat into a primary loop working fluid; a first turboexpander coupled to the first heat exchanger and operable to expand the primary loop working fluid to produce at least one of electricity and mechanical work; a second heat exchanger coupled to the turboexpander and operable to reject heat from the primary loop working fluid and introduce heat into a secondary loop working fluid; a third heat exchanger coupled to the second heat exchanger and operable to reject additional heat from the primary loop working fluid; a first compressor coupled to the third heat exchanger and operable to increase pressure of the primary loop working fluid; a second turboexpander coupled to the second heat exchanger and operable to expand the secondary loop working fluid to produce at least one of electricity and mechanical work; a fourth heat exchanger coupled to the second turboexpander and operable to reject heat from the secondary loop working fluid; and a second compressor coupled to the fourth heat exchanger and operable to increase pressure of the secondary loop working fluid.

In particular embodiments, the first compressor comprises: one or more intermediate compressors operable to increase pressure of the primary loop working fluid, and one or more intermediate cooling heat exchangers coupled between the one or more intermediate compressors operable to reject heat from the primary loop working fluid. The second compressor may comprise: one or more intermediate compressors operable to increase pressure of the secondary loop working fluid; and one or more intermediate cooling heat exchangers coupled between the one or more intermediate compressors operable to reject heat from the secondary loop working fluid.

In particular embodiments, the first heat exchanger comprises two or more heat exchangers, the first turboexpander comprises two or more turboexpanders, and the second heat exchanger comprises two or more heat exchangers. The two or more heat exchangers of the first heat exchanger are operable to introduce waste heat into the primary loop working fluid both before and after initial expansion from a first turboexpander of the two or more turboexpanders. The two or more turboexpanders are operable to expand the primary loop working fluid and produce at least one of electricity and mechanical work. The two or more heat exchangers of the second heat exchanger are operable to reject heat from the primary loop working fluid from respective first turboexpander sections and introduce heat into the secondary loop working fluid.

In particular embodiments, the second heat exchanger comprises a fifth heat exchanger coupled to a sixth heat exchanger. The fifth heat exchanger is operable to reject heat from both the primary loop working fluid and the secondary loop working fluid from the second turboexpander and introduce heat into the secondary loop working fluid from the second compressor. The sixth heat exchanger is operable to reject heat from the primary loop working fluid and introduce heat into the secondary loop working fluid from the fifth heat exchanger.

In particular embodiments, the second heat exchanger is operable to reject heat from both the primary loop working fluid and the secondary loop working fluid from the second turboexpander and introduce heat into the secondary loop working fluid from the second compressor.

In particular embodiments, the waste heat comes from at least one of combustion gases of a hydrocarbon source, combustion exhaust of a gas turbine; and gases from a combustion chamber. At least one of the primary loop working fluid and secondary loop working fluid may comprise carbon dioxide. The waste heat recovery system may be disposed on a floating vessel.

According to some embodiments, a method for supercritical waste heat recovery comprises: introducing waste heat into a primary loop working fluid at a first heat exchanger; expanding the primary loop working fluid to produce at least one of electricity and mechanical work at a first turboexpander coupled to the first heat exchanger; rejecting heat from the primary loop working fluid and introducing heat into a secondary loop working fluid at a second heat exchanger coupled to the turboexpander; rejecting additional heat from the primary loop working fluid at a third heat exchanger coupled to the second heat exchanger; increasing pressure of the primary loop working fluid at a first compressor coupled to the third heat exchanger; expanding the secondary loop working fluid to produce at least one of electricity and mechanical work at a second turboexpander coupled to the second heat exchanger; rejecting heat from the secondary loop working fluid at a fourth heat exchanger coupled to the second turboexpander; and increasing pressure of the secondary loop working fluid at a second compressor coupled to the fourth heat exchanger.

In particular embodiments, increasing pressure of the primary loop working fluid at the first compressor comprises increasing pressure of the primary loop working fluid at one or more intermediate compressors and rejecting heat of the primary loop working fluid at one or more intermediate cooling heat exchangers between one or more intermediate compressors. Increasing pressure of the secondary loop working fluid at the second compressor may comprise increasing pressure of the secondary loop working fluid at one or more intermediate compressors and rejecting heat of the secondary loop working fluid at one or more intermediate cooling heat exchangers between one or more intermediate compressors.

In particular embodiments, the first heat exchanger comprises two or more heat exchangers, the first turboexpander comprises two or more turboexpanders, and the second heat exchanger comprises two or more heat exchangers. The method further comprises: introducing waste heat into the primary loop working fluid both before and after initial expansion from a first turboexpander of the two or more turboexpanders at the two or more heat exchangers of the first heat exchanger; expanding the primary loop working fluid and producing at least one of electricity and mechanical work at the two or more turboexpanders; and rejecting heat from the primary loop working fluid from respective first turboexpander sections and introducing heat into the secondary loop working fluid at the two or more heat exchangers of the second heat exchanger.

In particular embodiments, the second heat exchanger comprises a fifth heat exchanger coupled to a sixth heat exchanger. The method further comprises: rejecting heat from both the primary loop working fluid and the secondary loop working fluid from the second turboexpander and introducing heat into the secondary loop working fluid from the second compressor at the fifth heat exchanger; and rejecting heat from the primary loop working fluid and introducing heat into the secondary loop working fluid from the fifth heat exchanger at the sixth heat exchanger.

In particular embodiments, the method further comprises rejecting heat from both the primary loop working fluid and the secondary loop working fluid from the second turboexpander and introducing heat into the secondary loop working fluid from the compressor at the second heat exchanger.

In particular embodiments, the waste heat comes from at least one of combustion gases of a hydrocarbon source, combustion exhaust of a gas turbine, and gases from a combustion chamber. At least one of the primary loop working fluid and secondary loop working fluid may comprise carbon dioxide. The waste heat recovery system may be disposed on a floating vessel.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating a nested loop supercritical CO₂ (sCO₂) waste heat recovery system (WHRS), according to some embodiments;

FIG. 2 is a block diagram illustrating the compression step with intercooling, according to some embodiments;

FIG. 3 is a block diagram illustrating the turboexpansion step with reheating, according to some embodiments;

FIG. 4 is a block diagram illustrating the nested loop sCO₂ WHRS with a triple input/triple output heat exchanger, according to some embodiments;

FIG. 5 illustrates an example integration of the nested loop sCO₂ WHRS within power modules on a floating vessel, according to some embodiments;

FIG. 6 is a block diagram illustrating the nested loop sCO₂ WHRS directly using combusted hydrocarbon gases as a heat source, according to some embodiments;

FIG. 7 is a block diagram illustrating the nested loop sCO₂ WHRS indirectly using combusted hydrocarbon gases as a heat source, according to some embodiments;

FIG. 8 is a block diagram illustrating the nested loop sCO₂ WHRS using gas combustion turbine exhaust as a heat source, according to some embodiments;

FIG. 9 is a block diagram illustrating the nested loop sCO₂ WHRS indirectly using pulverized coal combustion gas as a heat source, according to some embodiments; and

FIG. 10 is a flow diagram illustrating an example method for waste heat recovery, according to some embodiments.

### DETAILED DESCRIPTION

A waste heat recovery system (WHRS) is typically used to convert thermal energy into other forms of useful energy such as electricity or mechanical work. A WHRS utilizes one or more chemical compounds, such as water or an organic compound, as a working fluid to transfer energy.

A supercritical CO₂ (sCO₂) WHRS may be used for power generation. Current commercial sCO₂ and Organic Rankine Cycle (ORC) processes use a recuperator to increase thermal efficiency by extracting excess heat after the turboexpansion step and transferring it back into the Rankine cycle after the compression step. While a recuperator enables high thermal efficiencies, it limits the lower temperature range for waste heat extraction.

Particular embodiments described herein obviate the problems described above and include a nested loop sCO₂ process that replaces the recuperator with a heat exchanger that supplies heat for a separate sCO₂ Rankine cycle. The waste heat source first introduces heat into the primary sCO₂ Rankine cycle, which after extracting useful work from the primary cycle, transfers remaining heat into the secondary sCO₂ Rankine cycle where a second turboexpander produces work. Remaining heat may then be expelled through a cooling heat exchanger.

Some embodiments include further refinements to improve thermal efficiency for the sCO₂ WHRS. As temperature increases, the power requirement of the compression step increases. While compression is required to increase pressure of the working fluid, compression also increases the working fluid temperature. To reduce power consumption during the compression step, intercooling may be performed whereby intermediate stages of compression are performed with cooling between compression stages. By reducing the temperature at each intermediate stage, the required work to achieve the desired pressure decreases. In addition, lowering the temperature before the reheat step facilitates a greater amount of thermal energy recovery. Broadening the temperature range at which thermal energy is recovered is especially useful for open loop thermal processes such as the Brayton cycle or other combustion processes.

While the heat transfer and thermodynamic properties of sCO₂ are better than steam for waste heat recovery, temperature pinch points still exist to some degree that place limitations on the process that necessitate a larger heat exchanger temperature delta. The temperature delta may be lowered by reheating a portion of the CO₂ stream during the expansion step of the primary loop, which also further increases efficiency.

Some embodiments may integrate the process with a triple input heat exchanger that performs recuperation solely with the final loop and then cooling with the previous loop (e.g., simultaneously cooling the primary loop and recuperating the secondary loop for a two loop system). The triple input heat exchanger results in further improvements in efficiency.

Because of the nested nature of the process, it should be understood that development of a third or fourth interior loop is a derivative of this process. The phrases “primary loop” and “secondary loop” are intended to convey a parent-child relationship between two respective loops throughout this disclosure and may be applied to any number of nested child loops.

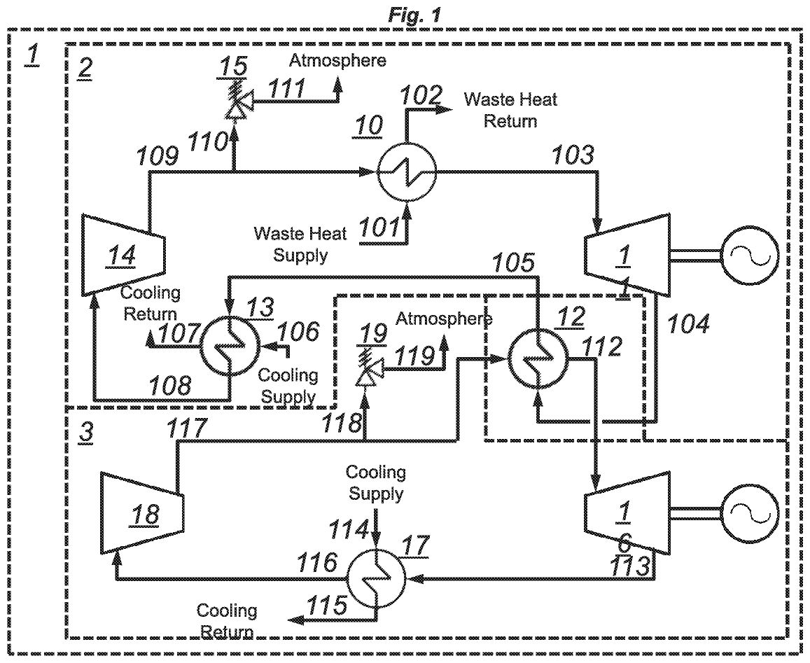

In general, particular embodiments include a nested loop sCO₂ WHRS for generating mechanical work and/or electrical power. Also described herein are processes and methods suitable for the nested loop sCO₂ WHRS, including combined cycle power generation, coal fired power, and floating power generation. Particular embodiments and their advantages are best understood by reference to FIGS. 1-10, wherein like reference numbers indicate like features.

FIG. 1 is a block diagram illustrating a nested loop Supercritical CO₂ (sCO₂) waste heat recovery system (WHRS), according to some embodiments. Nested loop sCO₂ WHRS 1 includes primary Rankine cycle loop 2 and secondary Rankine cycle loop 3.

Primary loop 2 processes sCO₂ as the working fluid. Primary loop 2 includes first heat exchanger 10 operable to heat CO₂ stream 109 and subsequently cool waste heat supply stream 101. Waste heat return stream 102 leaves heat exchanger 10 cooled. CO₂ leaves first heat exchanger 10 in a heated supercritical state as sCO₂ stream 103, which is coupled to turboexpander 11.

The term “coupled” as used herein when referring to one component or stream being coupled to another component or stream refers to any piping, tubing, or any suitable conveyance for transporting a working fluid, such as CO₂ in the illustrated examples, from one component to another.

Primary loop 2 includes first turboexpander 11 operable to expand sCO₂ stream 103 to a lower pressure where it leaves as sCO₂ stream 104. Output sCO₂ stream 104 is coupled to second heat exchanger 12.

Both primary loop 2 and secondary loop 3 include second heat exchanger 12, which is operable to cool primary loop 2 sCO₂ stream 104 and subsequently heat secondary loop 3 CO₂ stream 117. Primary loop 2 sCO₂ stream 105 leaves second heat exchanger 12 cooled and secondary loop 3 sCO₂ stream 112 leaves in a heated supercritical state. Output sCO₂ stream 105 is coupled to third heat exchanger 13. Output sCO₂ stream 112 is coupled to turboexpander 16.

Primary loop 2 may include one or more third heat exchanger(s) 13, which are operable to cool primary loop 2 sCO₂ stream 105 and subsequently warm cooling supply stream 106. CO₂ stream 108 leaves third heat exchanger(s) 13 cooled and cooling return stream 107 leaves heated. Output CO₂ stream 108 is coupled to first compressor 14.

In some embodiments, third heat exchanger(s) 13 may comprise one or more fan condenser type(s) with ambient air or gas as cooling supply 106 and return 107 streams. In other embodiments, third heat exchanger(s) 13 may comprise one or more shell and tube type or equivalent exchanger(s) with cooling water or another thermal fluid as cooling supply 106 and return 107 streams.

Primary loop 2 includes first compressor 14, which is operable to increase the pressure of stream 108 where it leaves as CO₂ stream 109, thus completing the primary loop. Primary loop 2 includes first relief valve 15 to safely relieve excess pressure from first compressor 14, where CO₂ stream 110 receives excess pressure from CO₂ stream 109 and is subsequently relieved to atmosphere through CO₂ stream 111. Care should be taken in the material selection of relief valve 15 with possible cold embrittlement caused by rapid expansion of CO₂ to atmospheric conditions due to auto-refrigeration.

Secondary loop 3 receives heat from second heat exchanger 12, which heated CO₂ stream 117 into sCO₂ stream 112. Secondary loop 3 includes second turboexpander 16, operable to expand sCO₂ stream 112 to a lower pressure where it leaves as sCO₂ stream 113. Output sCO₂ stream 113 is coupled to fourth heat exchanger 17.

Secondary loop 3 may contain one or more fourth heat exchanger(s) 17, which are operable to cool secondary loop 3 sCO₂ stream 113 and subsequently warm cooling supply stream 114. Cooling return stream 115 leaves fourth heat exchanger(s) 17 heated. Output CO₂ stream 116 leaves fourth heat exchanger(s) 17 cooled. Output CO₂ stream 116 is coupled to second compressor 18.

In some embodiments, fourth heat exchanger(s) 17 may comprise one or more fan condenser type(s) with ambient air or gas as the cooling supply 114 and return 115 streams. In other embodiments, fourth heat exchanger(s) 17 may comprise one or more shell and tube type or equivalent exchanger(s) with cooling water or another thermal fluid as cooling supply 114 and return 115 streams.

Secondary loop 3 includes second compressor 18, which is operable to increase the pressure of stream 116 where it leaves as CO₂ stream 117, thus completing the secondary loop. Secondary loop 3 includes first relief valve 19 to safely relieve excess pressure from second compressor 18, where CO₂ stream 118 receives excess pressure from CO₂ stream 117 and is subsequently relieved to atmosphere through CO₂ stream 119. Care should be taken in the material selection of relief valve 19 with possible cold embrittlement caused by rapid expansion of CO₂ to atmospheric conditions due to auto-refrigeration.

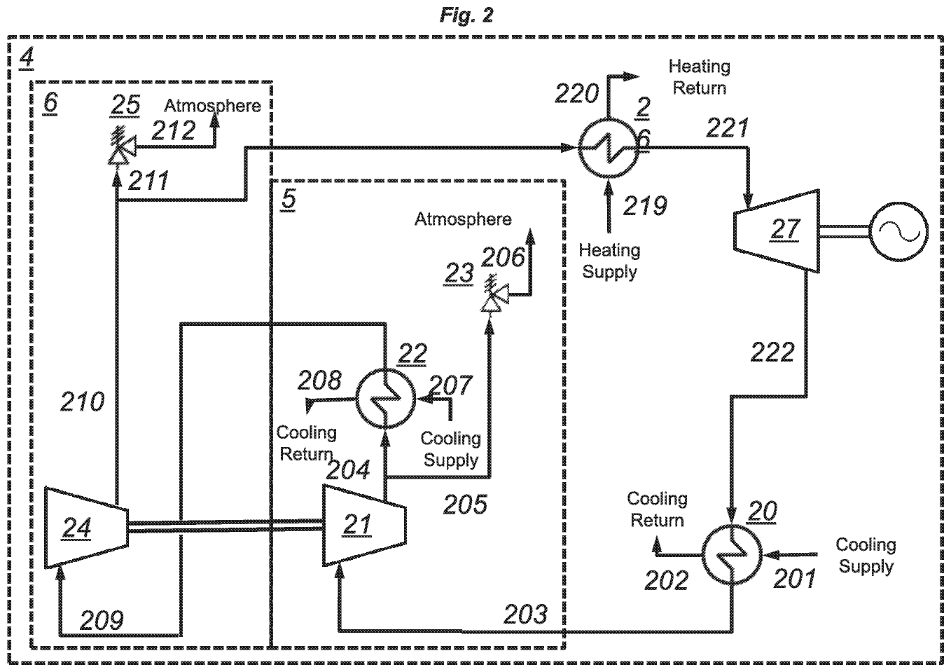

FIG. 2 is a block diagram illustrating the compression step with intercooling, according to some embodiments. Intercooling step 5 may be applied upstream of any compression step 6 from any Rankine cycle loop 4, including primary Rankine cycle loop 2 and secondary Rankine cycle loop 3 from FIG. 1.

As a compressor increases the pressure of a fluid, the process subsequently heats the fluid as well, which increases the amount of work required to further increase the pressure. Specifically for CO₂, the enthalpy change per unit mass of material has a relatively sharp increase starting at the critical point, and likewise in an isenthalpic line at higher pressures (e.g., 31° C. at 7.4 MPa, 45° C. at 10 MPa, and 60° C. at 20 MPa). This likewise rapidly increases the temperature during the compression cycle. To maximize the amount of thermal energy captured from open loop processes during the heating step, additional cooling is desirable to both reduce the temperature and the total amount of work required to pressurize CO₂.

According to some embodiments, the process including either compressor 14 of Rankine cycle primary loop 2 or compressor 18 of Rankine cycle secondary loop 3 from FIG. 1 may be modified to include compression intercooling step 5. During intercooling, CO₂ is supplied to first compressor 21 by cooling heat exchanger 20 via CO₂ stream 203 (CO₂ stream 108 in primary loop 2 or CO₂ stream 116 in secondary loop 3 from FIG. 1).

FIG. 2 provides an example derivation with one additional compressor, though intercooling step 5 may include one or more repetitions of the same equipment and streams indicated. Each repetition of the compressor (e.g., compressor 21) may or may not be driven from the same axis as the other compressors, including final compressor 24 in FIG. 2.

Rankine cycle 4 begins with heat exchanger 20, which is operable to cool sCO₂ stream 222 and subsequently warm cooling supply stream 201. Heated cooling return stream 202 and cooled CO₂ stream 203 leave heat exchanger 20. Output CO₂ stream 203 is coupled to compressor 21.

In intercooling step 5, compressor 21 is operable to partially compress CO₂ stream 203 to CO₂ stream 204. Output CO₂ stream 204 is coupled to heat exchanger 22 and relief valve 23.

Relief valve 23 is included downstream of compressor 21 to safely relieve excess pressure from compressor 21, where CO₂ stream 205 receives excess pressure from CO₂ stream 204 and is subsequently relieved to atmosphere through CO₂ stream 206.

Heat exchanger 22 is operable to cool partially compressed CO₂ stream 204 and subsequently warm cooling supply stream 207. Cooling return stream 208 leaves heat exchanger 22 heated. Output CO₂ stream 209 leaves heat exchanger 22 cooled. Output CO₂ stream 209 is coupled to final compressor 24.

In some embodiments, heat exchanger 22 may comprise a fan condenser type with ambient air or gas as cooling supply 207 and return 208 streams. In other embodiments, heat exchanger 22 may comprise a shell and tube type or equivalent exchanger with cooling water or another thermal fluid as the cooling supply stream 207 and return stream 208.

Intercooling step 5 CO₂ outlet stream 209 may then either supply a subsequent staged compression step 5 with CO₂ as another stream 203, or it may supply final compression step 6 with CO₂. Final compression step 6 includes final compressor 24, which is operable to increase the pressure of CO₂ stream 209 where it leaves as high pressure CO₂ stream 210. High pressure CO₂ stream 210 is coupled to heat exchanger 26 and relief valve 25.

High pressure CO₂ stream 210 supplies heat exchanger 26 with CO₂ to be heated to resume the Rankine cycle. Relief valve 25 is included downstream of compressor 24 to safely relieve excess pressure from compressor 24, where CO₂ stream 211 receives excess pressure from CO₂ stream 210 and is subsequently relieved to atmosphere through CO₂ stream 212. Care should be taken in the material selection of relief valve 25 with possible cold embrittlement caused by rapid expansion of CO₂ to atmospheric conditions due to auto-refrigeration.

Rankine cycle 4 is then completed by receiving heated sCO₂ stream 221 and sending it to turboexpander 27, operable to expand high pressure sCO₂ stream 221 to low pressure sCO₂ stream 222.

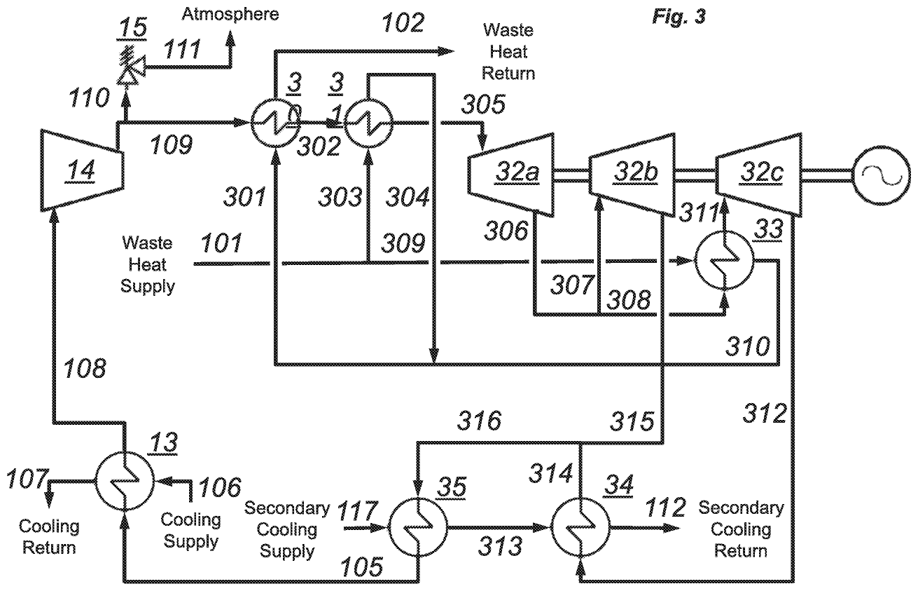

FIG. 3 is a block diagram illustrating the turboexpansion step with reheating, according to some embodiments. Reheating may be added to either primary loop 2 or secondary loop 3 from FIG. 1. For the purposes of simplicity, modifications to primary loop 2 are illustrated and described in this section but the same approach may be derived for secondary loop 3.

Reheating facilitates further thermal energy recovery from certain processes, which may result in increased overall efficiency. Reheating is typically accomplished by splitting first heat exchanger 10, first turboexpander 11, and second heat exchanger 12 (from FIG. 1) into multiple sections/copies as follows:

Compressor 14 is coupled to first heat exchanger section 30. High pressure CO₂ stream 109 downstream of compressor 14 enters first heat exchanger section 30, which is operable to provide initial heating to the high pressure sCO₂ stream and provide final cooling to partially cooled waste heat stream 301, which leave exchanger section 30 as partially heated high pressure sCO₂ stream 302 and cooled waste heat stream 102, respectively. Partially heated high pressure sCO₂ stream 302 is coupled to first heat exchanger section 31.

Partially heated high pressure sCO₂ stream 302 downstream of first heat exchanger section 30 enters first heat exchanger section 31, which is operable to provide high temperature heating to the high pressure sCO₂ stream and provide initial cooling to waste heat supply stream 303 (the first split from waste heat supply stream 101), which leave heat exchanger section 31 as fully heated sCO₂ stream 305 and partially cooled first split waste heat stream 304. Fully heated sCO₂ stream 305 is coupled to turboexpander section 32a.

Fully heated sCO₂ stream 305 downstream of first heat exchanger section 31 enters first turboexpander section 32a, which is operable to initially expand sCO₂ and generate useful work and produce partially expanded sCO₂ stream 306. Partially expanded sCO₂ stream 306 is split between first split sCO₂ stream 307 and second split sCO₂ stream 308.

First split sCO₂ stream 307 downstream of partially expanded sCO₂ stream 306 and first turboexpander section 32a enters first turboexpander section 32b. First turboexpander section 32b is operable to provide final expansion to first split sCO₂ stream 307 and generate useful work and produce first split low pressure sCO₂ stream 315.

Second split sCO₂ stream 308 downstream of partially expanded sCO₂ stream 306 and first turboexpander section 32a enters first heat exchanger section 33. First heat exchanger section 33 is operable to provide trim heating to second split sCO₂ stream 308 and provide initial cooling to waste heat supply stream 309 (the other split from waste heat supply stream 101), which leave first heat exchanger section 33 as trim heated sCO₂ stream 311 and partially cooled second split waste heat stream 310, respectively.

Trim heated sCO₂ stream 311 downstream of first heat exchanger section 31 enters first turboexpander section 32c, which is operable to provide final expansion to the sCO₂ stream and generate useful work and produce second split low pressure sCO₂ stream 312. Partially cooled first split waste heat stream 304 and partially cooled second split waste heat stream 310 are combined to produce partially cooled waste heat stream 301.

Second split low pressure sCO₂ stream 312 downstream of first turboexpander section 32c enters second heat exchanger section 34, which is operable to provide cooling to the second split low pressure sCO₂ stream 312 and heating to intermediate secondary cooling stream 313, which leave second heat exchanger section 34 as partially cooled second split low pressure sCO₂ stream 314 and secondary cooling return stream 112 (derivative of second heat exchanger 12 and heated high pressure sCO₂ stream 112 from FIG. 1).

First split low pressure sCO₂ stream 315 and partially cooled second split low pressure sCO₂ stream 314 combine to form integrated low pressure sCO₂ stream 316. Integrated low pressure sCO₂ stream 316 enters second heat exchanger section 35, which is operable to provide cooling to integrated low pressure sCO₂ stream 316 and heating to secondary cooling supply 117, which leave second heat exchanger section 35 as cooled low pressure sCO₂ stream 105 and heated intermediate secondary cooling stream 313, respectively.

Second split low pressure sCO₂ stream 312 downstream of first turboexpander section 32c enters second heat exchanger section 34, which is operable to provide initial cooling to the low pressure sCO₂ stream and provide final heating to intermediate secondary cooling stream 313, which respectively leave exchanger section 34 as partially cooled second split low pressure sCO₂ stream 314 and secondary cooling return stream 112 (derivative of second heat exchanger 12, secondary loop 3 high pressure CO₂ stream 117, and primary loop 2 low pressure sCO₂ stream 105 from FIG. 1).

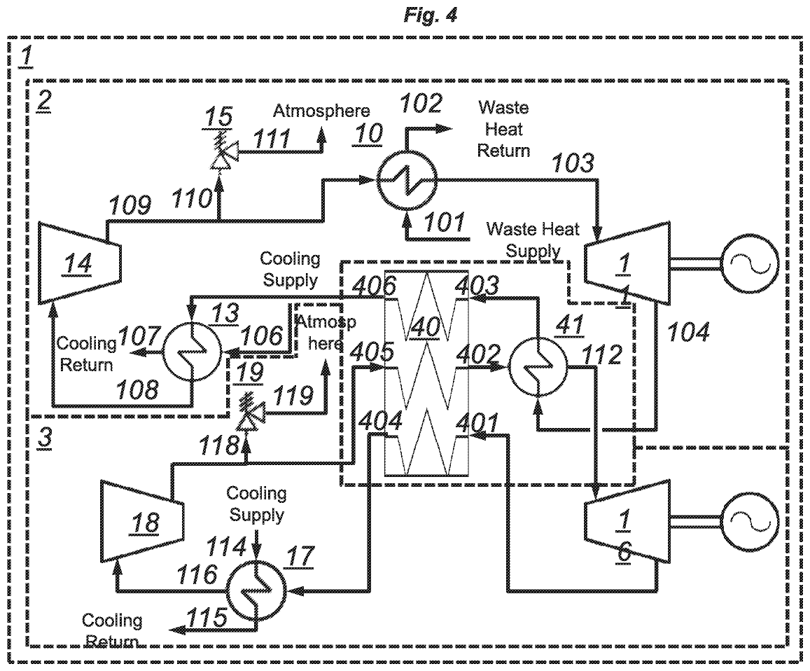

FIG. 4 is a block diagram illustrating the nested loop sCO₂ WHRS with a triple input/triple output exchanger, according to some embodiments. Triple input/output exchanger 40 combined with second heat exchanger 41 expands the functionality of second heat exchanger 12 from FIG. 1, which in certain embodiments results in further increases in thermal efficiency.

Triple input/output exchanger 40 may be inserted into any nested loop sCO₂ WHRS 1 treating second heat exchanger 12 (from FIG. 1) as separate fifth and sixth heat exchangers 40 and 41 or as a modification to second heat exchanger 12 split into two sections as heat exchanger sections 40 and 41. The first section 40 of second heat exchanger 12 incorporates thermal communication between the primary loop 2 and secondary loop 3 sCO₂ streams and a third recuperating stream, and the second section 41 is the remaining thermal communication between the primary loop 2 and secondary loop 3. FIG. 4 is identical to FIG. 1 except for the insertion of triple input/output exchanger 40 which ties into existing parts of FIG. 1 as follows in the next two paragraphs:

From primary loop 2, partially cooled sCO₂ stream 403 downstream of second heat exchanger 41 (an insertion into cooled sCO₂ stream 105 downstream of second heat exchanger 12 in FIG. 1) is the first input stream into exchanger 40, which is operable to heat secondary loop 3 sCO₂ stream 405. From secondary loop 3, low pressure sCO₂ stream 401 downstream of second turboexpander 16 (an insertion into low pressure sCO₂ stream 113 downstream of second turboexpander 16 in FIG. 1) is the second input stream into exchanger 40, which is also operable to heat secondary loop 3 sCO₂ stream 405. From secondary loop 3, high pressure sCO₂ stream 405 downstream of second compressor 18 (an insertion into high pressure CO₂ stream 117 downstream of second compressor 18 in FIG. 1) is the third input stream into exchanger 40, which is operable to simultaneously cool partially cooled sCO₂ stream 403 and low pressure sCO₂ stream 401.

From the first input stream 403 that is cooled within exchanger 40 comes the first output stream as cooled low pressure CO₂ stream 406, which supplies warm CO₂ to third heat exchanger 13 in primary loop 2 (this completes the insertion into cooled sCO₂ stream 105 downstream of second heat exchanger 12 in FIG. 1). From the second input stream 401 that is cooled within exchanger 40 comes the second output stream as cooled low pressure CO₂ stream 404, which supplies warm CO₂ to fourth heat exchanger(s) 17 (this completes the insertion into cooled sCO₂ stream 105 downstream of second heat exchanger 12 in FIG. 1). From the third input stream 405 that is warmed within exchanger 40 comes the third output stream as warmed high pressure CO₂ stream 402, which supplies cool sCO₂ to heat exchanger 41 (this completes the insertion into high pressure CO₂ stream 117 downstream of second compressor 18 in FIG. 1).

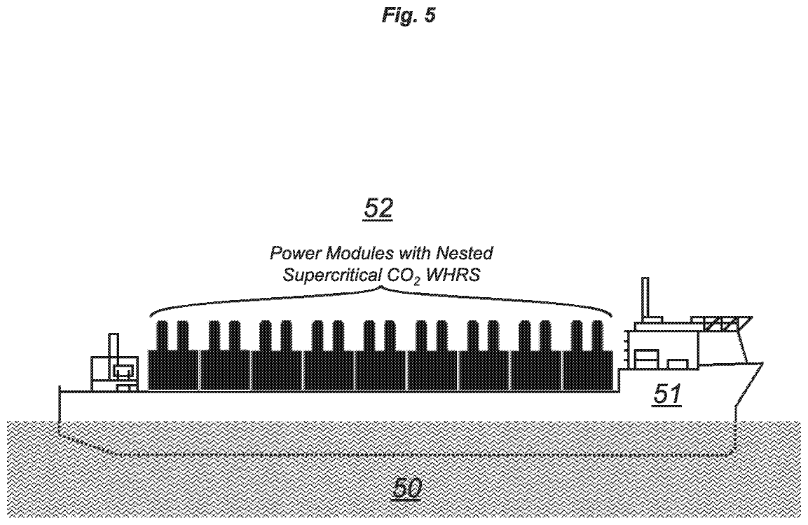

FIG. 5 illustrates an example integration of the nested loop sCO₂ WHRS within power modules on a floating vessel, according to some embodiments. Floating vessel 51, also known as a floating power unit (FPU) according to some embodiments, includes one or more power module(s) 52 onboard. Each power module 52 may contain a single nested loop sCO₂ WHRS 1 or share it between one or more other power module(s) 52.

FPU 51 is located within water body 50, which may also provide cooling either directly or indirectly to cooling supply 106 and/or cooling supply 114. According to some embodiments, FPU 51 may not be in a floating condition and/or may be intentionally bottom founded. An FPU may be useful in certain locations where investing in a land based power plant is considered a high risk and asset mobility and flexibility is desired, and in some cases may result in lower capital expenditures. An FPU is also useful for its turn-key approach to providing electricity to various parts of the world along coastlines, islands, and various inland waterways which may be constructed more rapidly in a controlled environment instead of onsite.

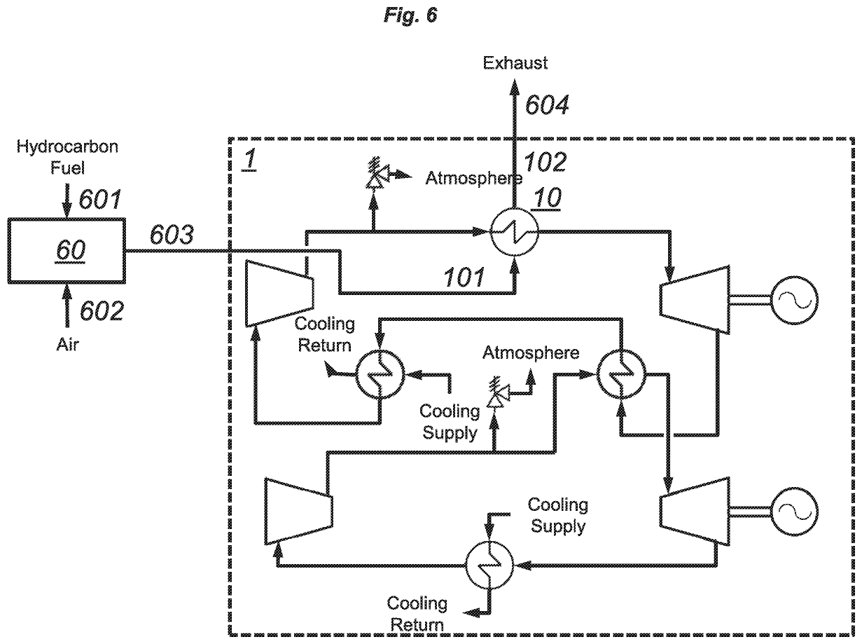

FIG. 6 is a block diagram illustrating the nested Loop sCO₂ WHRS directly using combusted hydrocarbon gases as the heat source, according to some embodiments. Hydrocarbon fuel stream 601 and air stream 602 are combined within system 60 where they are combusted to produce high temperature exhaust stream 603.

Exhaust stream 603 then directly feeds nested loop sCO₂ WHRS 1 waste heat supply stream 101 with high temperature combustion product gases. First exchanger 10 is operable to remove heat from waste heat supply stream 101 where the waste heat stream is subsequently cooled and leaves as waste heat return stream 102. Waste heat stream 102 then leaves the nested loop sCO₂ WHRS 1 as exhaust stream 604.

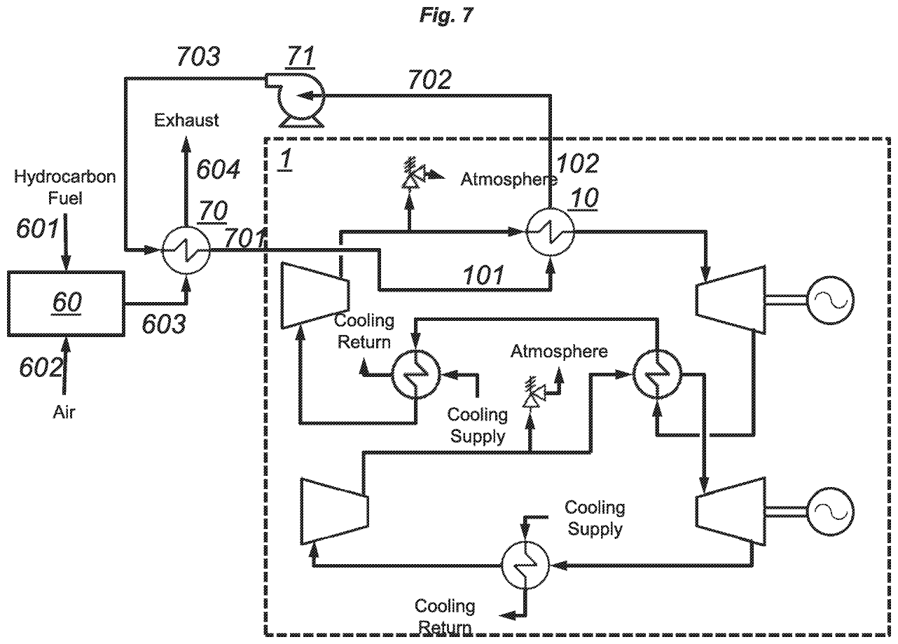

FIG. 7 is a block diagram illustrating the nested loop sCO₂ WHRS indirectly using combusted hydrocarbon gases as the heat source, according to some embodiments. Hydrocarbon fuel stream 601 and air stream 602 are combined within system 60 where they are combusted to produce high temperature exhaust stream 603.

Exhaust stream 603 is coupled with exhaust heat exchanger 70 where the stream supplies the exchanger with hot gas and cool thermal fluid 603 receives heat from heat exchanger 70. These streams leave exhaust heat exchanger 70 as cooled exhaust stream 604 and hot thermal fluid stream 701, respectively.

Hot thermal fluid stream 701 supplies waste heat to nested loop sCO₂ WHRS 1 through waste heat supply stream 101. First exchanger 10 is operable to remove heat from waste heat supply stream 101 where the waste heat stream is subsequently cooled and leaves as waste heat return stream 102. Waste heat return stream 102 then leaves the nested loop sCO₂ WHRS 1 as cooled thermal fluid stream 702. Thermal fluid stream 702 is coupled to thermal fluid pump 71.

Thermal fluid pump 71 is operable to circulate the thermal fluid in a closed loop fashion between nested loop sCO₂ WHRS 1 and exhaust heat exchanger 70 and may either be located upstream or downstream of exhaust heat exchanger 70. Typically, thermal fluid pump 71 is located upstream of exhaust heat exchanger 70 where it supplies flow through cool thermal fluid stream 703. Thermal fluid stream 703 is coupled to heat exchanger 70.

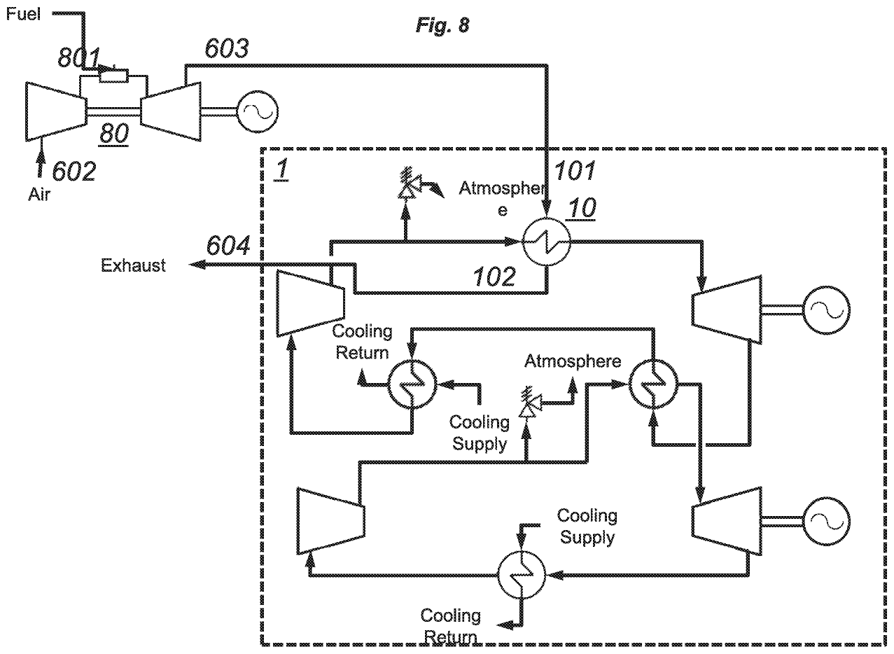

FIG. 1s a block diagram illustrating the nested loop sCO₂ WHRS using gas combustion turbine exhaust as the heat source, according to some embodiments. FIG. 8 is a particular example of the components illustrated in FIG. 6 and comprises an implementation of this WHRS for a combined cycle power generation system. In most embodiments, fuel stream 801 (hydrocarbon fuel stream 601 in FIG. 6) is natural gas or another gaseous hydrocarbon fuel, though in other embodiments fuel stream 801 may be a liquid fuel.

Gas combustion turbine 80 receives air from stream 602 and fuel from stream 801 and is operable to produce mechanical work or electricity. Exhaust gas stream 603, which leaves gas combustion turbine 80 directly feeds nested loop sCO₂ WHRS 1 waste heat supply stream 101 with high temperature combustion product gases. First exchanger 10 is operable to remove heat from waste heat supply stream 101 where the waste heat stream is subsequently cooled and leaves as waste heat return stream 102. Waste heat stream 102 then leaves the nested loop sCO₂ WHRS 1 as exhaust stream 604.

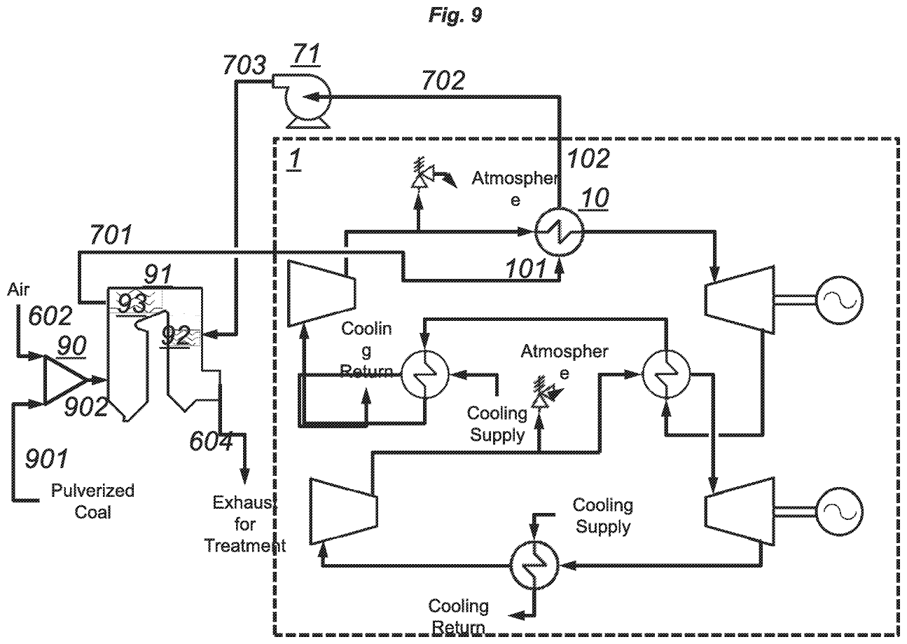

FIG. 1s a block diagram illustrating the nested loop sCO₂ WHRS indirectly using pulverized coal combustion gas as the heat source, according to some embodiments. FIG. 9 is a particular example of the components illustrated in FIGURE. In most embodiments, stream 901 (hydrocarbon fuel stream 601 in FIGURE) consists of pulverized coal, though in other embodiments could be other solid hydrocarbon materials such as wood or agricultural byproducts, hurricane debris, or other solid waste products.

According to some embodiments, an FPU 51 configured with power module(s) 52 configured as illustrated in FIG. 5 may be useful for islands where solid waste disposal is a frequent issue. Stream 901 is blended with air stream 502 through mixer 90 where it provides combustion chamber 91 with the appropriate feed materials through stream 902. Combustion chamber 91 includes economizer(s) 92 and superheater(s) 93, which have a similar functionality to exhaust heat exchanger 60 in FIGURE.

Economizer(s) 92 are operable to absorb residual heat from combustion chamber 91 and heat cold thermal fluid 703. Economizer(s) 92 then supplies superheater(s) 93 with warmed thermal fluid. Superheater(s) 93 is operable to absorb the majority of heat from combustion chamber 91 and outputs hot thermal fluid 701. Pump 71 and thermal fluid stream 701, 702, and 703 have the same functionality as described for FIGURE.

Cooled exhaust gas 604 leaves combustion chamber 91 where it is sent to downstream treatment equipment such as those for fly ash removal, flue gas desulfurization (FGD), and NOx removal. According to some embodiments, an FPU 51 configured with power module(s) 52 configured as illustrated in FIG. 5 may be useful for coastal locations where a compact, lower cost seawater FGD system may be installed and readily utilized.

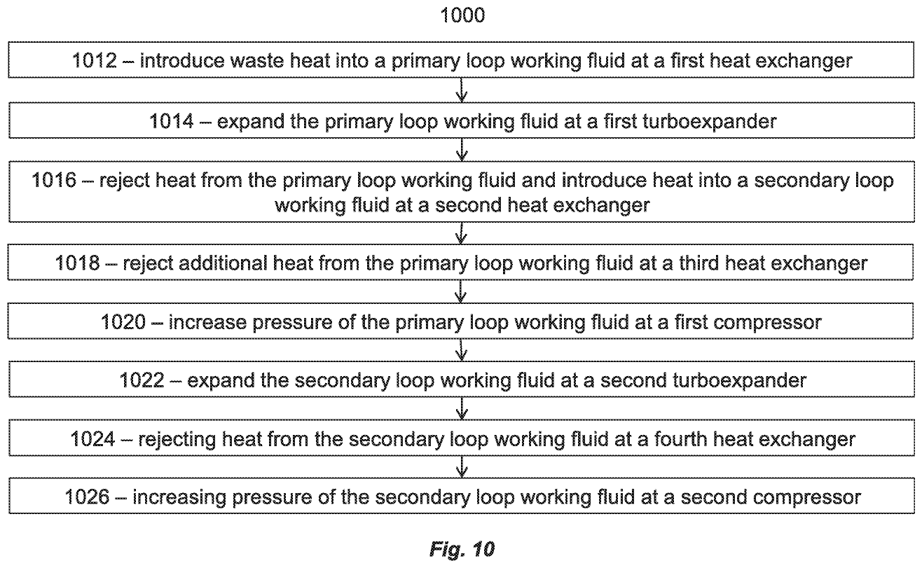

FIG. 10 is a flow diagram illustrating an example method for waste heat recovery, according to some embodiments. One or more steps of method 1000 illustrated in FIG. 10 may be implemented by the components of the waste heat recovery systems illustrated in FIGS. 1-9.

The method begins at step 1012, where the supercritical waste heat recovery system introduces waste heat into a primary loop working fluid at a first heat exchanger. For example, supercritical waste heat recovery system 1 of FIG. 1 introduces waste heat into the working fluid of loop 2 at first heat exchanger 10.

At step 1014, the supercritical waste heat recovery system expands the primary loop working fluid to produce at least one of electricity and mechanical work at a first turboexpander coupled to the first heat exchanger. For example, first turboexpander 11 of FIG. 1 is coupled to first heat exchanger 10 and first turboexpander 11 expands the working fluid of primary loop 2.

At step 1016, the supercritical waste heat recovery system rejects heat from the primary loop working fluid and introduces heat into a secondary loop working fluid at a second heat exchanger coupled to the second turboexpander. For example, second heat exchanger 12 of FIG. 1 is coupled to first turboexpander 11, third heat exchanger 13, and second turboexpander 16. Second heat exchanger 12 rejects heat from primary loop 2 working fluid and introduces heat into secondary loop 3 working fluid.

At step 1018, the supercritical waste heat recovery system rejects additional heat from the primary loop working fluid at a third heat exchanger coupled to the second heat exchanger. For example, third heat exchanger 13 of FIG. 1 is coupled to second heat exchanger 12. Third heat exchanger 13 rejects additional heat from primary loop 2 working fluid.

At step 1020, the supercritical waste heat recovery system increases pressure of the primary loop working fluid at a first compressor coupled to the third heat exchanger. For example, first compressor 14 of FIG. 1 is coupled to third heat exchanger 13.

First compressor 14 increases pressure of primary loop 2 working fluid.

At step 1022, the supercritical waste heat recovery system expands the secondary loop working fluid to produce at least one of electricity and mechanical work at a second turboexpander coupled to the second heat exchanger. For example, second turboexpander 16 of FIG. 1 is coupled to second heat exchanger 12. Second turboexpander 16 expands second loop 3 working fluid to produce at least one of electricity and mechanical work.

At step 1024, the supercritical waste heat recovery system rejects heat from the secondary loop working fluid at a fourth heat exchanger coupled to the second turboexpander. For example, fourth heat exchanger 17 is coupled to second turboexpander 16. Fourth heat exchanger 17 rejects heat from secondary loop 3 working fluid.

At step 1026, the supercritical waste heat recovery system increases pressure of the secondary loop working fluid at a second compressor coupled to the fourth heat exchanger. For example, second compressor 18 is coupled to fourth heat exchanger 17.

Second compressor 18 increases pressure of secondary loop 3 working fluid.

In some embodiments, the components described with respect to the example supercritical waste heat recovery system of method 1000 may comprise one or more components. For example, in some embodiments increasing pressure of the primary loop 2 working fluid at the first compressor 14 comprises increasing pressure of the primary loop 2 working fluid at one or more intermediate compressors 21 and rejecting heat of the primary loop 2 working fluid at one or more intermediate cooling heat exchangers 22 between one or more intermediate compressors 21. As a particular example, some embodiments replace or modify first compressor 14 of FIG. 1 with intercooling step 5 of FIG. 2.

Similarly, increasing pressure of the secondary loop working fluid at the second compressor may comprise one or more components. For example, in some embodiments increasing pressure of the secondary loop 3 working fluid at one or more intermediate compressors 21 and rejecting heat of the secondary loop 3 working fluid at one or more intermediate cooling heat exchangers 22 between one or more intermediate compressors 21. As a particular example, some embodiments replace or modify second compressor 18 of FIG. 1 with intercooling step 5 of FIG. 2.

In some embodiments, the first heat exchanger comprises two or more heat exchangers, the first turboexpander comprises two or more turboexpanders, and the second heat exchanger comprises two or more heat exchangers. For example, the method may further comprise: introducing waste heat into the primary loop 2 working fluid both before and after initial expansion from a first turboexpander 32a of the two or more turboexpanders 32a-32c at the two or more heat exchangers 30, 31, and 33 of the first heat exchanger 10; expanding the primary loop 2 working fluid and producing at least one of electricity and mechanical work at the two or more turboexpanders 32a-32c; and rejecting heat from the primary loop 2 working fluid from respective first turboexpander sections 32a-32c and introducing heat into the secondary loop working fluid at the two or more heat exchangers 34 and 35 of the second heat exchanger 12. A particular example is illustrated in FIG. 3 where the first heat exchanger 10 comprises heat exchangers 30, 31, and 33; the first turboexpander 11 comprises turboexpanders 32a, 32b, and 32c, and the second heat exchanger 12 comprises heat exchangers 34 and 35.

In some embodiments, the second heat exchanger comprises a fifth heat exchanger coupled to a sixth heat exchanger. For example, the method may comprise: rejecting heat from both the primary loop 2 working fluid and the secondary loop 3 working fluid from the second turboexpander 16 and introducing heat into the secondary loop 3 working fluid from the second compressor 18 at the fifth heat exchanger 40; and rejecting heat from the primary loop 2 working fluid and introducing heat into the secondary loop 3 working fluid at the fifth heat exchanger 40 and sixth heat exchanger 41. An example is illustrated in FIG. 4, where the second heat exchanger 12 comprises fifth and sixth heat exchangers 40 and 41.

Modifications, additions, or omissions may be made to method 1000 of FIG. 10. Additionally, one or more steps in the method of FIG. 10 may be performed in parallel or in any suitable order.

Although the examples herein are described with respect to CO₂ as the working fluid, particular embodiments may apply to other suitable working fluids operating in the supercritical region.

While several embodiments have been provided in the present disclosure, it should be understood that the disclosed systems and methods might be embodied in many other specific forms without departing from the spirit or scope of the present disclosure. The present examples are to be considered as illustrative and not limited to the details given herein. For example, the various elements or components may be combined and/or integrated in another system and/or certain features may be omitted, or not implemented.

In addition, techniques, systems, subsystems, and methods described and illustrated in the various embodiments as discrete or separate may be combined and/or integrated with other systems, modules, techniques and/or methods without departing from the scope of the present disclosure. Other items shown or discussed as coupled and/or directly coupled or communicating with each other may be indirectly coupled or communicating through some interface, device, or intermediate component whether electrically, mechanically or otherwise. Other examples of changes, substitutions, and alterations are ascertainable by one skilled in the art and could be made without departing from scope disclosed herein.

1. A supercritical waste heat recovery system comprising:
a first heat exchanger operable to introduce waste heat into a primary loop working fluid;
a first turboexpander coupled to the first heat exchanger, the first turboexpander operable to expand the primary loop working fluid to produce at least one of electricity and mechanical work;
a second heat exchanger coupled to the turboexpander, the second heat exchanger operable to reject heat from the primary loop working fluid and introduce heat into a secondary loop working fluid;
a third heat exchanger coupled to the second heat exchanger, the third heat exchanger operable to reject additional heat from the primary loop working fluid;
a first compressor coupled to the third heat exchanger, the first compressor operable to increase pressure of the primary loop working fluid;
a second turboexpander coupled to the second heat exchanger, the second turboexpander operable to expand the secondary loop working fluid to produce at least one of electricity and mechanical work;
a fourth heat exchanger coupled to the second turboexpander, the fourth heat exchanger operable to reject heat from the secondary loop working fluid; and
a second compressor coupled to the fourth heat exchanger, the second compressor operable to increase pressure of the secondary loop working fluid.

2. The supercritical waste heat recovery system of claim 1, wherein the first compressor comprises:
one or more intermediate compressors operable to increase pressure of the primary loop working fluid; and
one or more intermediate cooling heat exchangers coupled between the one or more intermediate compressors operable to reject heat from the primary loop working fluid.

3. The supercritical waste heat recovery system of claim 1, wherein the second compressor comprises:
one or more intermediate compressors operable to increase pressure of the secondary loop working fluid; and
one or more intermediate cooling heat exchangers coupled between the one or more intermediate compressors operable to reject heat from the secondary loop working fluid.

4. The supercritical waste heat recovery system of claim 1, wherein:
the first heat exchanger comprises two or more heat exchangers;
the first turboexpander comprises two or more turboexpanders;
the second heat exchanger comprises two or more heat exchangers;
the two or more heat exchangers of the first heat exchanger are operable to introduce waste heat into the primary loop working fluid both before and after initial expansion from a first turboexpander of the two or more turboexpanders;
the two or more turboexpanders are operable to expand the primary loop working fluid and produce at least one of electricity and mechanical work; and
the two or more heat exchangers of the second heat exchanger are operable to reject heat from the primary loop working fluid from respective first turboexpander sections and introduce heat into the secondary loop working fluid.

5. The supercritical waste heat recovery system of claim 1, wherein:
the second heat exchanger comprises a fifth heat exchanger coupled to a sixth heat exchanger;
the fifth heat exchanger is operable to reject heat from both the primary loop working fluid and the secondary loop working fluid from the second turboexpander and introduce heat into the secondary loop working fluid from the second compressor; and
the sixth heat exchanger is operable to reject heat from the primary loop working fluid and introduce heat into the secondary loop working fluid from the fifth heat exchanger.

6. The supercritical waste heat recovery system of claim 1, wherein:
the second heat exchanger is operable to reject heat from both the primary loop working fluid and the secondary loop working fluid from the second turboexpander and introduce heat into the secondary loop working fluid from the compressor.

7. The supercritical waste heat recovery system of claim 1, wherein the waste heat comes from at least one of:
combustion gases of a hydrocarbon source;
combustion exhaust of a gas turbine; and
gases from a combustion chamber.

8. The supercritical waste heat recovery system of claim 1, wherein at least one of the primary loop working fluid and secondary loop working fluid comprises carbon dioxide.

9. The supercritical waste heat recovery system of claim 1, wherein the waste heat recovery system is disposed on a floating vessel.

10. A method for supercritical waste heat recovery, the method comprising:
introducing waste heat into a primary loop working fluid at a first heat exchanger;
expanding the primary loop working fluid to produce at least one of electricity and mechanical work at a first turboexpander coupled to the first heat exchanger;
rejecting heat from the primary loop working fluid and introducing heat into a secondary loop working fluid at a second heat exchanger coupled to the turboexpander;
rejecting additional heat from the primary loop working fluid at a third heat exchanger coupled to the second heat exchanger;
increasing pressure of the primary loop working fluid at a first compressor coupled to the third heat exchanger;
expanding the secondary loop working fluid to produce at least one of electricity and mechanical work at a second turboexpander coupled to the second heat exchanger;
rejecting heat from the secondary loop working fluid at a fourth heat exchanger coupled to the second turboexpander; and
increasing pressure of the secondary loop working fluid at a second compressor coupled to the fourth heat exchanger.

11. The method of claim 10, wherein increasing pressure of the primary loop working fluid at the first compressor comprises:
increasing pressure of the primary loop working fluid at one or more intermediate compressors; and
rejecting heat of the primary loop working fluid at one or more intermediate cooling heat exchangers between one or more intermediate compressors.

12. The method of claim 10, wherein increasing pressure of the secondary loop working fluid at the second compressor comprises:
increasing pressure of the secondary loop working fluid at one or more intermediate compressors; and
rejecting heat of the secondary loop working fluid at one or more intermediate cooling heat exchangers between one or more intermediate compressors.

13. The method of claim 10, wherein:
the first heat exchanger comprises two or more heat exchangers;
the first turboexpander comprises two or more turboexpanders;
the second heat exchanger comprises two or more heat exchangers;
the method further comprising:
introducing waste heat into the primary loop working fluid both before and after initial expansion from a first turboexpander of the two or more turboexpanders at the two or more heat exchangers of the first heat exchanger;
expanding the primary loop working fluid and producing at least one of electricity and mechanical work at the two or more turboexpanders; and
rejecting heat from the primary loop working fluid from respective first turboexpander sections and introducing heat into the secondary loop working fluid at the two or more heat exchangers of the second heat exchanger.

14. The method of claim 10, wherein:
the second heat exchanger comprises a fifth heat exchanger coupled to a sixth heat exchanger;
the method further comprising:
rejecting heat from both the primary loop working fluid and the secondary loop working fluid from the second turboexpander and introducing heat into the secondary loop working fluid from the second compressor at the fifth heat exchanger; and
rejecting heat from the primary loop working fluid and introducing heat into the secondary loop working fluid from the fifth heat exchanger at the sixth heat exchanger.

15. The method of claim 10, further comprising rejecting heat from both the primary loop working fluid and the secondary loop working fluid from the second turboexpander and introducing heat into the secondary loop working fluid from the compressor at the second heat exchanger.

16. The method of claim 10, wherein the waste heat comes from at least one of:
combustion gases of a hydrocarbon source;
combustion exhaust of a gas turbine; and
gases from a combustion chamber.

17. The method of claim 10, wherein at least one of the primary loop working fluid and secondary loop working fluid comprises carbon dioxide.

18. The method of claim 10, wherein the waste heat recovery system is disposed on a floating vessel.
